(19) United States
(12) Patent Application Publication
(10) Pub. No.: US 2026/0017989 A1
(43) Pub. Date: Jan. 15, 2026

(54) Method and Apparatus for Determining at least one Defective Vehicle

(71) Applicant: Bayerische Motoren Werke Aktiengesellschaft, Muenchen (DE)

(72) Inventors: Julia Hollmayer-Lahrsow, Ratzenhofen (DE); Marco Bross, Sao Paulo (BR); Florian Eberl, Fraunberg (DE); Markus Frank, Muenchen (DE)

(21) Appl. No.: 18/870,310

(22) PCT Filed: Feb. 8, 2023
(86) PCT No.: PCT/EP2023/053103

§ 371 Date: Sep. 29, 2025

(30) Foreign Application Priority Data
Jul. 7, 2022 (DE) 10 2022 116 924.3

(51) Int. Cl. G07C 5/08

(52) U.S. Cl. CPC G07C 5/0808

(57) ABSTRACT

A method determines at least one defective vehicle that is a subset of a specified main set of vehicles and the vehicles are divided into vehicle types. The method includes determining data channel actual values which represent a respective quantity of transmitted data in a first data channel or a second data channel for at least one vehicle. The method also includes determining a vehicle-specific ratio value based on a ratio of a data channel actual value of the first data channel to a data channel actual value of the second data channel for the at least one vehicle. The method further includes determining a deviation value for the at least one vehicle, wherein each deviation value represents a deviation of the ratio value from a specified expected value for the vehicle type, and classifying whether the at least one vehicle is defective on the basis of the deviation value.

The present application is the U.S. national phase of PCT Application PCT/EP2023/053103 filed on Feb. 8, 2023, which claims priority of German patent application no. 10 2022 116 924.3 filed on Jul. 7, 2022, the entire contents of which are incorporated herein by reference.

### TECHNICAL FIELD

The present disclosure relates generally to determining at least one defective vehicle.

### BACKGROUND

There exists a need to specify a method in which at least one defective vehicle is determined particularly easily and quickly. There also exists a need for a device and a computer program that can execute such a method, as well as a computer-readable storage medium storing such a computer program.

### SUMMARY

The above-described needs, as well as others, are satisfied by at least some of the embodiment disclosed and claimed herein.

A first aspect is a method for determining at least one defective vehicle. The at least one defective vehicle is a subset of a specified main set of vehicles.

For example, the vehicles of the specified main set are networked with each other. For example, the vehicles of the specified main set are networked by means of a device. For example, each of the vehicles of the specified main set is connected by means of a communication link with the device, in particular an external device. The device is, for example, a server, in particular a backend server.

The vehicles of the specified main set are divided into a plurality of vehicle types. The vehicle type is, for example, a type designation of the vehicle. For example, each vehicle type includes several of the vehicles. Vehicles included in one vehicle type are not included in another vehicle type, for example. The vehicle types group the vehicles, for example.

According to at least one embodiment of the method, data channel actual values, which represent a respective quantity of transmitted data in a first or a second data channel for the at least one vehicle are, determined.

For example, the data channel actual values are determined on the basis of a time interval. The time interval can be, for example, at least 1 hour and at most 48 hours, in particular 24 hours. In particular, the time interval represents a day of the week.

For example, the transmitted data from at least one vehicle during operation of the vehicle is transmitted to the external device, where they are stored and processed, for example. To determine the respective data channel actual values for example, the transmitted data of at least one vehicle is processed within the time interval. For example, the data channel actual values are a quantity of data transmitted within the time interval.

The transmitted data are, for example, messages comprising status data of at least one vehicle. If a vehicle is operated, this vehicle, for example, sends a specified message comprising the status data to the external device. For example, the status data are data of the vehicle that are displayed to a user in the vehicle and/or on a mobile device.

A data channel can represent a channel divided into several frames, which in turn can be divided into several time slots. Likewise, a data channel may represent channels divided into several time blocks or frequency blocks. Furthermore, a data channel can be represented by a resource that is used by a specified unit, such as a sensor or a control unit.

According to at least one embodiment of the method, a vehicle-specific ratio value is determined based on a ratio of the respective data channel actual value of the first data channel to the data channel actual value of the second data channel for the at least one vehicle. For example, in the vehicle-specific ratio value, the quantity of transmitted data of the first data channel, represented by the data channel actual value of the first data channel, is set in a ratio to the quantity of transmitted data of the second data channel, represented by the data channel actual value of the second data channel.

According to at least one embodiment of the method, an expected value is specified. For example, the specified expected value is determined in a vehicle type-specific manner. The expected value is based on the ratio values of all vehicles in the main set of each vehicle type.

For example, the expected value may represent an average of the ratio values of all vehicles of a vehicle type. The expected value of a vehicle type can be determined on the basis of a time interval, for example. The time interval can be, for example, at least 1 hour and at most 48 hours, in particular 24 hours. In particular, the time interval for determining the expected value depends on the time interval for determining the data channel actual values. For example, the expected values of the vehicle types are determined temporally after the determination of the ratio value of at least one vehicle. Advantageously, the expected value is therefore not stationary, but can change dynamically.

According to at least one embodiment of the method, a deviation value is determined for at least one vehicle, wherein the deviation value represents a deviation of the ratio value from the expected value. The deviation value can, for example, represent a difference between the ratio value of at least one vehicle and the expected value of the vehicle type of at least one vehicle. For example, each vehicle of the specified main set has a deviation value.

Furthermore, each vehicle of the main set has at least one property in addition to the deviation value, for example. The property comprises, for example, one of the following information items: vehicle type, product update, software version, combination of control units, associated domestic market, backend hub, production date. For example, the vehicles of the main set have at least some of the same characteristics.

For example, the information comprising the product update specifies which type of updates a software, in particular a control software, of the vehicle comprises. Similarly, the information comprising the software version specifies the state of the software, in particular the control of software, the vehicle. The information comprising the combination of control units specifies, for example, which control units are installed in the vehicle and/or which control units are in communication with each other. The information comprising the assigned domestic market specifies the geographical region in which the vehicle is mainly operated. The information comprising the backend hub specifies which external backend hub the vehicle is connected to.

According to at least one embodiment of the method, it is classified whether the at least one vehicle is defective on the basis of the deviation value. The at least one vehicle is classified as defective, for example, if the deviation value is greater than the specified expected value.

By dividing the data into two data channels, defective vehicles are determined more precisely when determining a vehicle-specific ratio value by means of the respective data channel actual values of a first or a second data channel. By determining a deviation of the ratio value from the expected value, the deviation value is determined independently of the driving behavior of the respective vehicle. As a result, the deviation value is calculated correctly for a vehicle that transmits hardly/no data over a certain period of time, for example due to a long service life in which the vehicle is not used. The classification of whether the vehicle is defective, on the basis of the deviation value, thus becomes more efficient and less error prone.

According to at least one embodiment of the method, the at least one vehicle is assigned to a subgroup depending on the deviation values. Vehicles classified as defective are assigned to a specified subgroup depending on at least one specified property. By comparing the deviation value with the expected value, it is determined whether at least one vehicle is defective. For example, at least one vehicle is classified as defective if the deviation value is 1 percent, 5 percent or 10 percent above the expected value.

For example, the subgroup comprises defective vehicles with which the deviation values are comparatively large. The vehicle-specific ratio value of the vehicles from the subgroup of defective vehicles is therefore different from the vehicle-type-specific expected value of the vehicles from the subgroup of defective vehicles. This means that vehicles from the subgroup of defective vehicles send much less or much more data on the first data channel than on the second data channel compared to an expected value.

With such a method, a subgroup comprising defective vehicles can be determined particularly easily and quickly. For example, these defective vehicles comprise common properties that are responsible for a fault.

For example, if the error relates only to a subset of a specified main set of vehicles, in particular a subset of networked vehicles of a fleet, the subgroup of defective vehicles can be identified by the specified method. This subgroup comprises, for example, defective vehicles that have only certain vehicle types of a backend hub with a specific software version and/or production date.

This means that the properties of the defective vehicles are known and corrective measures can be initiated in a targeted manner.

According to at least one embodiment of the method, a global median is determined when determining the subgroup of defective vehicles, which represents all the deviation values of the vehicles of the specified main set. In particular, the global median is a median of all deviation values.

According to at least one embodiment of the method, at least one first subgroup is determined on the basis of a first property when determining the subgroup of defective vehicles. The first property is, for example, a vehicle type of the vehicle.

According to at least one embodiment of the method, the at least one first subgroup has a first median, which has a maximum difference with respect to the global median.

According to at least one embodiment of the method, at least one second subgroup and at least one third subgroup are generated from the at least one first subgroup when determining the subgroup of defective vehicles.

According to at least one embodiment of the method, the at least one second subgroup has a second median on the basis of a second property. The second property is, for example, a product update of the vehicle. In particular, the second property is different from the first.

According to at least one embodiment of the method, the at least a third subgroup has a third median on the basis of a third property. The third property, for example, is a software version of the vehicle. In particular, he third property is different from the first property. Similarly, the third property is in particular different from the second property.

According to at least one embodiment of the method, a difference between the second median and the third median is maximized.

By determining a global median representing all deviation values of the vehicles of the specified main set, and a median for each further subgroup representing all deviation values of the vehicles within the respective subgroup, it is ensured that the defective vehicles of the main set can be distinguished from the non-defective vehicles.

Further subgroups are generated from at least one second subgroup and/or from at least one third subgroup on the basis of other properties, for example.

According to at least one embodiment of the method, the subgroup of defective vehicles is determined on the basis of a specified population size of the second subgroup and the third subgroup.

For example, the specified population size is a termination criterion of the method. In this case, the subgroup of defective vehicles is formed by the subgroup that is smaller than the specified population size. The specified population size of the subgroup of defective vehicles is specified on the basis of a statistical relevance. For example, the specified population size is so large that no over-adjustment is generated. For example, the specified population size of the subgroup of defective vehicles comprises at least 500 vehicles and at most 5000 vehicles.

If a population size of the first subgroup and/or the second group is larger than the specified population size, further subgroups are generated from the second subgroup and/or the third subgroup. The method is terminated, for example, if a population size of at least one of the other subgroups is smaller than the specified population size.

According to at least one embodiment of the method, the first, the second and the third properties each comprise at least one of the following information items: vehicle type, product update, software version, combination of control units, associated domestic market, backend hub, production date. If additional subgroups are generated, the other properties also comprise one of the above information items.

According to at least one embodiment of the method, the first, the second and the third properties differ from each other. In particular, the other properties used to generate the further subgroups also differ from each other.

A second aspect relates to a device for detecting defective vehicles. The device is designed to execute the method described here. All the features of the embodiment disclosed in connection with the method are therefore also disclosed in connection with the device and vice versa.

A third aspect relates to a computer program comprising commands which, when the computer program is executed by a computer, cause the computer to execute the method described here.

One aspect relates to a computer-readable storage medium on which the above-described computer program is stored.

Exemplary embodiments are described in more detail below by reference to the schematic drawings.

### BRIEF DESCRIPTION OF THE DRAWINGS

FIG. 1 shows a flow diagram of a method according to an exemplary embodiment,

FIG. 2 shows a schematic illustration of a system having a device according to an exemplary embodiment; and

FIG. 3 shows a schematic illustration describing the use of the method for determining a defective subgroup according to an exemplary embodiment.

### DETAILED DESCRIPTION

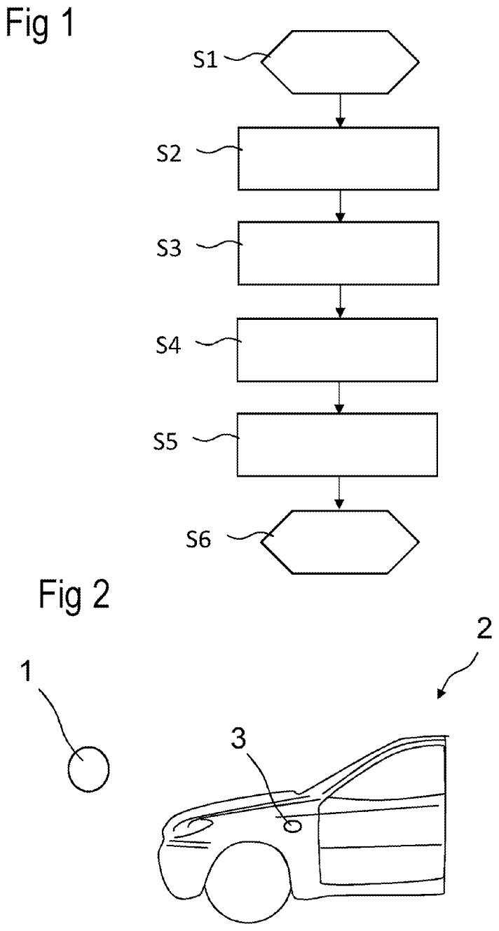

In the flow diagram of the method according to the embodiment of FIG. 1, a method step S1 is first carried out, in which a data channel actual value of a quantity of data to be transmitted in a first or a second data channel over the course of a day of the week for each vehicle of the specified main set is determined.

For example, each vehicle 2 of the specified main set of a networked vehicle fleet is designed to transmit data during operation via a first and at least one second data channel to a device 1, in particular an external device. These data are specified messages and comprise, for example, status data of the respective vehicle 2.

In a subsequent method step S2, a vehicle-specific ratio value can be determined for each vehicle 2 of the specified main set, which indicates a ratio of the quantity of data transmitted from the first data channel to the quantity of data transmitted from the second data channel over the course of a day of the week.

The ratio values can be determined after the data channel actual values have been determined.

In a further method step S3, an expected value can be formed for each vehicle type from the ratio values of each vehicle 2 of the specified main set, which represents an average value over all the ratio values of the vehicles of the specified main set of the respective vehicle type.

The generation of the expected values can take place after the determination of the ratio values.

Subsequently, a deviation value for each vehicle of the specified main set can be determined in a method step S4. The deviation value can be determined based on the difference between the ratio value and the expected value.

Based on the deviation value, in a further method step S5 it can be classified whether the vehicles of the specified main set are defective. Whether a vehicle is defective can be determined by comparing the deviation value of the respective vehicle with the expected value of the respective vehicle type. For example, the vehicle is classified as defective if the deviation value is 5 percent above or below the expected value.

Subsequently, in a method step S6, a subgroup of defective vehicles is determined on the basis of the deviation values, wherein the ratio value of the subgroup of defective vehicles is smaller than the expected value. The defective vehicles each comprise at least one-identical-property. If the ratio value of a vehicle over the course of a day of the week is significantly lower than the expected value over the course of the day of the week, in particular the same day of the week, the probability is increased that a fault is caused by said property.

The system according to the embodiment of FIG. 2 comprises a device 1, in particular an external device which is designed to be connected to a vehicle 2 via a communication link 3. The communication link 3 is designed to transmit the sent specified messages to the device 1.

The device 1 is designed to execute the method according to FIG. 1.

The device is formed, for example, in a backend server.

For this purpose, the device 1 has in particular a computing unit, a program and data memory, and, for example, one or more communication interfaces. The program and data memory and/or the computing unit and/or the communication interfaces can be implemented in one unit and/or distributed over multiple units.

For executing the method, in particular, a program for detecting defective vehicles is stored on the program and data memory of the device 1, which processes the above-described method.

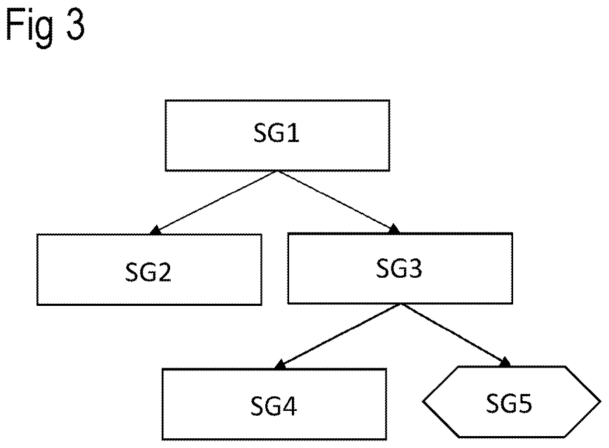

According to FIG. 3, a first subgroup SG1 is initially determined on the basis of a first property. The first property is information relating to a first product update, for example. All vehicles of the specified main set with this property are comprised in the first subgroup SG1.

In particular, the first subgroup SG1 has a first median, which has a maximum difference with respect to a global median, wherein the global median represents all deviation values of the vehicles 2. For example, the first subgroup SG1 comprises 600000 vehicles.

A second subgroup SG2 and a third subgroup SG3 are subsequently generated from the first subgroup SG1. The second subgroup SG2, for example, comprises the vehicles of the first subgroup SG1, in which the ratio value corresponds to the expected value. The third subgroup SG3, for example, comprises the vehicles of the first subgroup SG1, in which the ratio value is different from the expected value.

The second subgroup SG2 comprises vehicles on the basis of a second property. For example, the second property is information about a second product update. All vehicles of the second subgroup SG2 thus include vehicles with the first and second properties. In addition, the second subgroup SG2 has a second median.

The third subgroup SG3 comprises vehicles on the basis of a third property. The third property can be, for example, information relating to a domestic market. All vehicles of the third subgroup SG3 thus include vehicles with the first and third properties. In addition, the third subgroup SG3 has a third median.

The second subgroup SG2 and the third subgroup SG3 are selected in such a way that a difference between the second median and the third median is maximized.

Subsequently, further subgroups are generated from the third subgroup SG3 on the basis of other properties, namely a fourth subgroup SG4 and a fifth subgroup SG5. For example, the fourth subgroup SG4 comprises vehicles of the third subgroup SG3, where the ratio value corresponds to the expected value. The fifth subgroup SG5, for example, comprises the vehicles of the first subgroup SG1, in which the ratio value is different from the expected value. For example, the fifth subgroup SG5 only comprises 15000 vehicles.

This fifth subgroup SG5 corresponds to the subgroup of defective vehicles according to the method in connection with the exemplary embodiment of FIG. 1.

### LIST OF REFERENCE SIGNS

1 device
2 vehicle
3 communication device
SG1 first subgroup
SG2 second subgroup
SG3 third subgroup
SG4 fourth subgroup
SG5 fifth subgroup
S1 . . . . S6 method step

1.-10. (canceled)

11. A method for determining at least one defective vehicle, wherein the at least one defective vehicle is a subset of a specified main set of vehicles and the vehicles are divided into a plurality of vehicle types, comprising:
determining data channel actual values, which represent a respective quantity of transmitted data in a first data channel or a second data channel for at least one vehicle,
determining a vehicle-specific ratio value based on a ratio of a respective data channel actual value of the first data channel to a data channel actual value of the second data channel for the at least one vehicle,
determining a deviation value for the at least one vehicle, wherein each deviation value represents a deviation of the ratio value from a specified expected value for the vehicle type,
classifying whether or not the at least one vehicle is defective on the basis of the deviation value.

12. The method as claimed in claim 11, wherein the expected value is determined in a vehicle type-specific manner based on ratio values of all vehicles of the main set of a respective vehicle type.

13. The method as claimed in claim 12, wherein the expected value represents an average value over all the ratio values of the all of the vehicles of the main set of the respective vehicle type.

14. The method as claimed in claim 13, wherein a vehicle classified as defective is assigned to a specified subgroup depending on at least one specified property.

15. The method as claimed in claim 14, wherein a subgroup of defective vehicles is determined, wherein
a global median is determined which represents all deviation values of the vehicles of the specified main set,
at least one first subgroup is determined on the basis of a first property, wherein
the at least one first subgroup has a first median which has a maximum difference with respect to the global median,
at least one second subgroup and at least one third subgroup are generated from the at least one first subgroup, wherein
the at least one second subgroup has a second median based at least in part on a second property,
the at least one third subgroup has a third median based at least in part on a third property, and
a difference between the second median and the third median is maximized.

16. The method as claimed in claim 11, wherein a vehicle classified as defective is assigned to a specified subgroup depending on at least one specified property.

17. The method as claimed in claim 16, wherein a subgroup of defective vehicles is determined, wherein
a global median is determined which represents all deviation values of the vehicles of the specified main set,
at least one first subgroup is determined on the basis of a first property, wherein
the at least one first subgroup has a first median which has a maximum difference with respect to the global median,
at least one second subgroup and at least one third subgroup are generated from the at least one first subgroup, wherein
the at least one second subgroup has a second median based at least in part on a second property,
the at least one third subgroup has a third median based at least in part on a third property, and
a difference between the second median and the third median is maximized.

18. The method as claimed in claim 17,
wherein the subgroup of defective vehicles is determined based at least in part on a specified population size of one of the at least one second subgroup and one of the at least one third subgroup.

19. The method as claimed in claim 18, wherein:
each of the first property, the second property and the third property include at least one of the following information items: vehicle type, product update, software version, combination of control units, associated domestic market, backend hub, production date; and
the first property, the second property and the third property differ from each other.

20. The method as claimed in claim 17, wherein:
each of the first property, the second property and the third property include at least one of the following information items: vehicle type, product update, software version, combination of control units, associated domestic market, backend hub, production date; and
the first property, the second property and the third property differ from each other.

21. The method as claimed in claim 13, wherein each data channel actual value is determined based at least in part on multiple time intervals, wherein each time interval represents a day of the week.

22. The method as claimed in claim 11, wherein each data channel actual value is determined based at least in part on multiple time intervals, wherein each time interval represents a day of the week.

23. A device for determining at least one defective vehicle, which is designed to execute the method as claimed in claim 11.

24. A non-transitory computer-readable medium having a computer program comprising commands which, when executed by a computer, cause the computer to execute the method as claimed in claim 11.
